(19) United States
(12) Patent Application Publication
(10) Pub. No.: US 2008/0271291 A1
(43) Pub. Date: Nov. 6, 2008

(54) Multi-directional adjustment hinge

(76) Inventors: Ken-Ching Chen, Lu-Chu Hsiang (TW); Hsiu-Chiang Liang, Lu-Chu Hsiang (TW); Chun-Chiang Wang, Lu-Chu Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/797,512

(22) Filed: May 4, 2007

(51) Int. Cl. E05D 7/04

(52) U.S. Cl. 16/238

(57) ABSTRACT

A multi-directional adjustment hinge includes a head plate, an extension plate, a locating plate, a pivot pin, a spring tongue, an adjustment screw, and an adjustment cam. The head plate has a chamber. An arm extends from one end of the extension plate and another end of the extension plate is provided with a joint. A pair of sidewalls is disposed at both sides of the extension plate. Two lips are disposed at both sides of the locating plate to be inserted between the sidewalls and side edges of the joint. Each lip contains a protruding tab to hold against the joint. One side of the extension plate and the locating plate is linked to interact with each other by means of the adjustment screw. Another side of the locating plate and the joint is linked to interact with each other by means of the adjustment cam.

### BACKGROUND OF THE INVENTION

(a) Field of the Invention

The present invention is related to a hinge, and more particularly, to a multi-directional adjustment hinge comprised of compact components with a more reliably constructed adjustment.

(b) Description of the Prior Art

A furniture hinge commonly used to a cabinet is essentially comprised of a head plate, an extension arm, and a locating plate, wherein the extension arm is pivoted to the head plate to become a movable part, the head plate is usually fixed to an object including a door plank, the extension arm is connected to the locating plate secured on the cabinet, and an elastic member disposed in the head plate applies force on the extension arm to deliver a certain closing force when the door plank is pushed back to shut the cabinet.

The furniture hinge is further designed with a multi-directional adjustment in axes X, Y, and Z as taught in U.S. Pat. Nos. 6,470,531 B2, 6,643,895 B1, 6,647,591 B1, 6,694,567 B1, 6,779,233 B2, 6,845,544 B2, and 6,880,205 B2. Other than the head plate, four types of parts (not including adjustment screw or cam) as a minimum are included in the constructional design as disclosed in U.S. Pat. Nos. 6,647,591 B1 and 6,845,544 B2, resulting in higher cost in developing molds for those parts, complicate and tedious assembly process, and the problem of loosening structure at where the adjustment screw is provided after prolonged use.

### SUMMARY OF THE INVENTION

The primary purpose of the present invention is to provide a multi-directional adjustment hinge to solve the problem of a loosening structure of the hinge adjustment, allow more compact construction of the hinge, and reduce production cost.

To achieve the purpose, the present invention includes a head plate, an extension plate, a locating plate, a pivot pin, a spring tongue, an adjustment screw, and an adjustment cam. Wherein a chamber is disposed in the head plate, an arm extends from one end of the extension plate to pivot the extension plate to the head plate, and another end of the extension plate is inwardly curved and provided with a joint; a through hole is provided at a central portion of the extension plate; a pair of sidewalls is disposed at two sides of the extension plate; two lips are disposed at two sides of the locating plate to be inserted between the sidewalls and the side edges of the joint of the extension plate; each lip contains a protruding tab to hold against the joint; one side of the extension plate at where closer to the arm and the locating plate are linked to interact with each other by means of the adjustment screw; another side of the locating plate and the joint are linked to interact with each other by means of the adjustment cam; and the spring tongue is secured to the bottom of the chamber of the head plate by means of a locating portion and penetrating to hold against the arm by means of a force-applying portion.

Wherein, locating pieces and retainers are disposed on the bottom of the chamber to hold against the locating portion with the locating pieces compressing the locating portion to be secured in position.

Wherein, the retainers are disposed at where corresponding to the edge of the locating portion of the spring tongue.

Wherein, a cam portion is formed at one end of the arm of the extension plate penetrated by the pivot pin; and a slot is disposed on the arm at where closer to the cam portion; and the force-applying portion of the spring tongue penetrates through the slot to hold against the cam portion.

Wherein, a slit is disposed on the joint of the extension plate; a through hole is disposed on the locating plate; the adjustment cam is disposed with a riveting end and a cam base; the riveting end connects the adjustment cam to the through hole of the locating plate; and the cam base is received in the slit of the joint.

Wherein, a threaded hole is disposed on one end of the extension plate at where closer to the arm; the locating plate is formed with an insertion recess; the adjustment screw has a threaded portion and a ring groove; the threaded portion of the adjustment screw penetrates through the threaded hole; and the ring groove of the adjustment screw engages with the insertion recess.

Wherein, two retaining tabs and a strip hole are disposed on one end of the locating plate.

When compared to the prior art, the present invention provides the following effects and advantages:

a. The extension plate and the locating plate are two key components other than the head plate, the adjustment screw, and the adjustment cam in the present invention allowing easy assembly and lower production cost; and

b. The extension plate connects the locating plate by means of the inwardly bent joint; and where the connection takes place provides a proper elasticity; and by means of the elasticity, an excellent tension presents at where the adjustment screw connects the extension plate and another end of the locating plate not only to provide a firm connection but also to ensure a longer service life of the hinge by preventing the turning of the adjustment screw from getting too tight.

### BRIEF DESCRIPTION OF THE DRAWINGS

FIG. 1 is an exploded view of a preferred embodiment of the present invention (locating pieces not yet bent.).

FIG. 2 is a perspective view of the preferred embodiment of the present invention.

FIG. 3 is another exploded view showing the preferred embodiment of the present invention including an extension plate, a locating plate, an adjustment screw, and an adjustment cam.

FIG. 4 is a schematic view showing the preferred embodiment is adapted to a cabinet board and a door plank.

FIG. 5 is a schematic view showing an adjustment made (in the direction of axis Z) by the preferred embodiment of the present invention.

FIG. 6 is a schematic view showing another adjustment made (in the direction of axis X) by the preferred embodiment of the present invention.

FIG. 7 is a schematic view showing another adjustment made (in the direction of axis Y) by the preferred embodiment of the present invention.

### DETAILED DESCRIPTION OF THE PREFERRED EMBODIMENTS

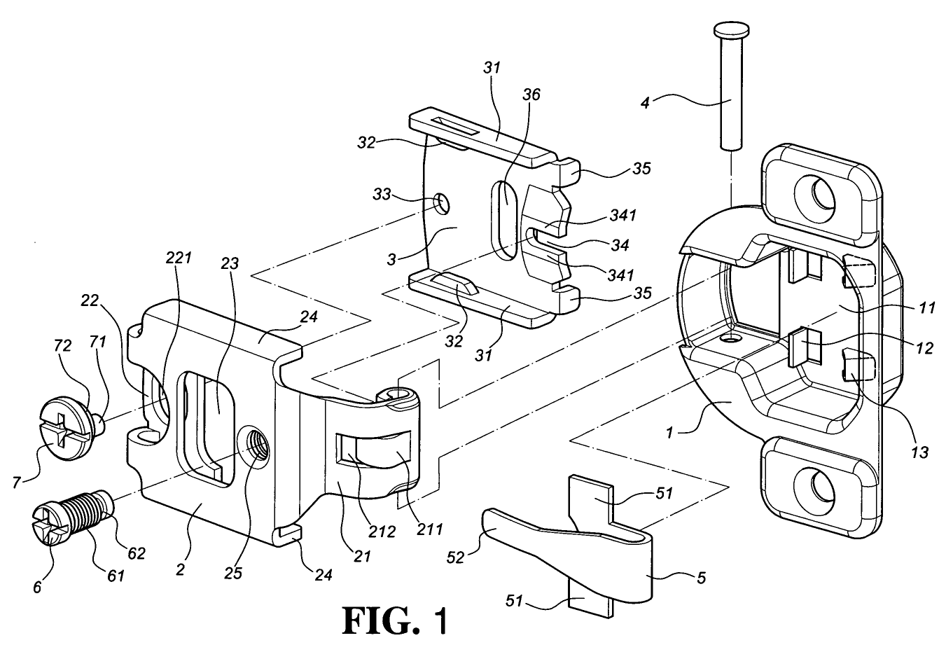

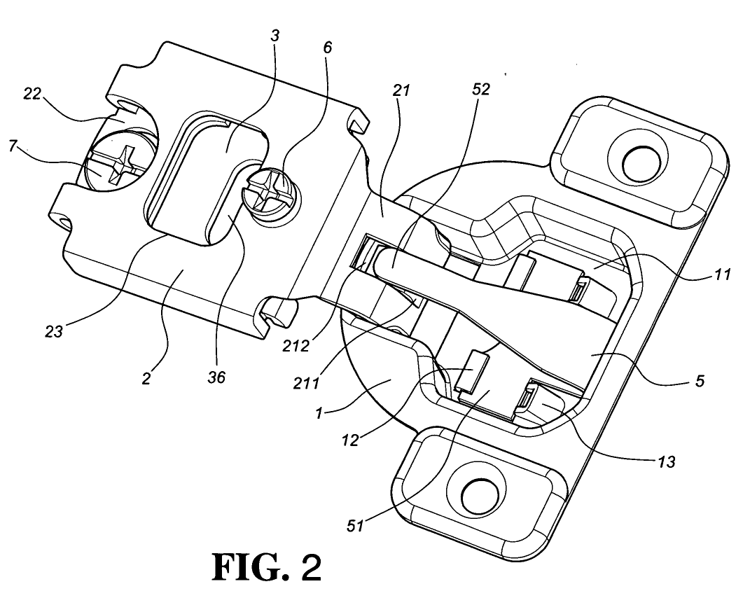

Referring to FIGS. 1 and 2, a preferred embodiment of the present invention comprises a head plate (1), an extension plate (2), a locating plate (3), a pivot pin (4), a spring tongue (5), an adjustment screw (6), and an adjustment cam (7).

The head plate (1) contains a chamber (11), and locating pieces (12) and retainers (13) are disposed at the bottom of the chamber (11).

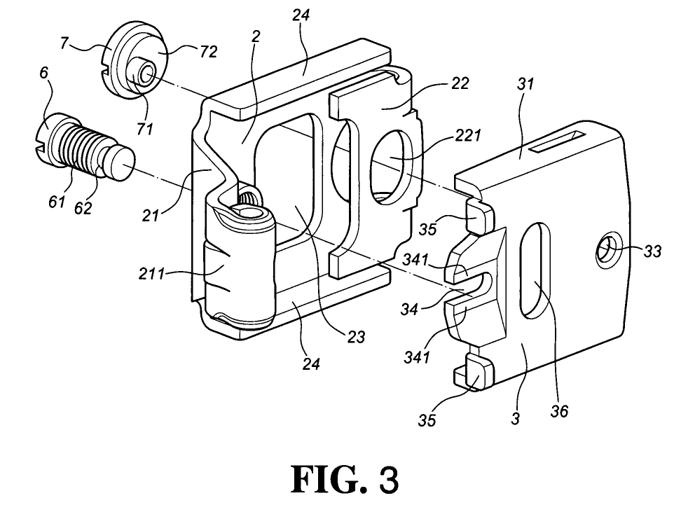

The extension plate (2), as illustrated in FIG. 3, is a plate provided with two opposite ends. A through hole (23) is disposed at a central portion of the extension plate (2). A pair of sidewalls (24) is provided at both sides of the extension plate (2). An arm (21) extends from one end of the extension plate (2) and a cam portion (211) formed at the end of the arm (21) extends into the chamber (11) of the head plate (1) to be pivoted to the head plate (1). The arm (21) is formed with a slot (212) adjacent to the cam portion (211). A joint (22) inwardly curved is disposed at another end of the extension plate (2). The joint (22) is formed with a slit (221). The extension plate (2) is formed with a threaded hole (25) close to the arm (21). The sidewalls (24) and the side edges of the joint (22) are spaced each other.

The locating plate (3) is provided with two lips (31) at both sides of the locating plate (3). The lips (31) are inserted between the sidewalls (24) and the side edges of the joint (22) of the extension plate (2). Each lip (31) is provided with a protruding tab (32) to hold against the joint (22). The locating plate (3) is formed with a through hole (33) corresponding in position to the slit (221) of the joint (22), and an insertion recess (34) defined by a pair of walls (341) separated from each other is disposed at where corresponding to the threaded hole (25) of the extension plate (2). Retaining tabs (35) are provided at two ends of the locating plate (3), as illustrated in FIG. 3. The locating plate (3) is formed with a strip hole (36).

The pivot pin (4) penetrates through the head plate (1) and the cam portion (211) of the arm (21) from the extension plate (2).

The spring tongue (5) includes a locating portion (51) and a force-applying portion (52). The locating portion (51) is attached to the bottom of the chamber (11) in the head plate (1). The retainers (12) hold against the edge of the locating portion (51), and the locating pieces (13) are pressed to secure the spring tongue (5) in position. The force-applying portion (52) of the spring tongue (5) penetrates through the slot (212) on the arm (21) of the extension plate (2) to compress the cam portion (211).

The adjustment screw (6) engaged one side of the extension plate (2) at where closer to the arm (21) connects the extension plate (2) to the locating plate (3). The adjustment screw (6) is provided with a threaded portion (61) and a ring groove (62). The threaded portion (61) penetrates through the threaded hole (25) and the ring groove (62) is inserted into the insertion recess (34). The ring groove (62) engages with the walls (341).

The adjustment cam (7) penetrating through the joint (22) of the extension plate (2) to connect to the locating plate (3) includes a riveting end (71) and a cam base (72). The adjustment cam (7) connects the through hole (33) by means of the riveting end (71) and extends into the slit (221) by means of the cam base (72).

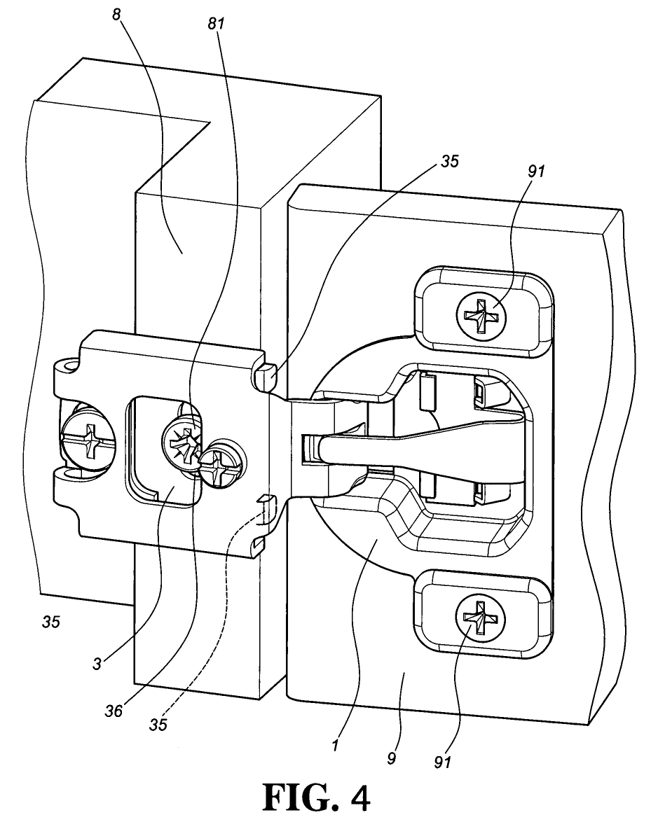

Now referring to FIG. 4 when the hinge of the preferred embodiment is assembled to a cabinet, the present invention has the retaining tabs (35) of the locating plate (3) holding against a side of a cabinet board (8), and a bolt (81) to penetrate through the strip hole (36) of the locating plate (3) thus to secure the hinge to the cabinet board (8) while the head plate (1) is secured to a door plank (9) of the cabinet with bolts (91).

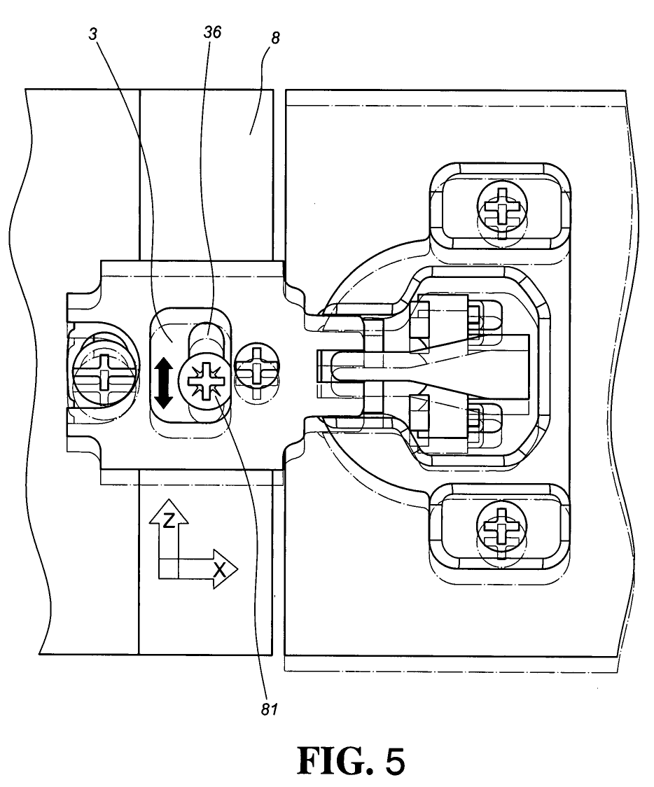

As illustrated in FIG. 5 when the hinge of the present invention is adjusted, the bolt (81) penetrates through the strip hole (36) is of the locating plate (3) and engages the cabinet board (8). Before fully tightening up the bolt (81), the adjustment is made with the locating plate (3) by taking advantage of a gap left in the strip hole (36) in a direction of axis Z according to the coordinates illustrated in FIG. 5.

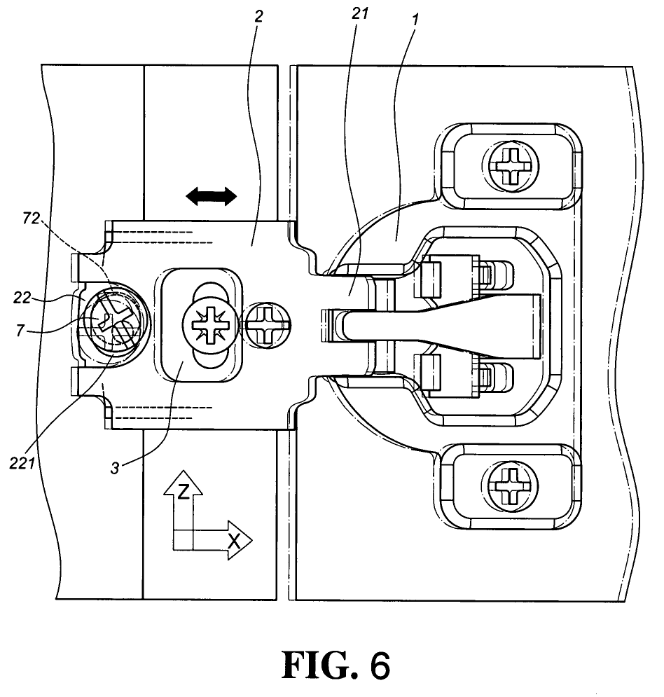

With the locating plate (3) serving as a reference point without moving as illustrated in FIG. 6, the adjustment cam (7) is turned for the cam base (71) of the adjustment cam (7) to push against the slit (221) of the joint (22) of the extension plate (2) for the arm (21) to drive the head plate (1) to execute displacement in a direction of axis X according to the coordinates illustrated in FIG. 6.

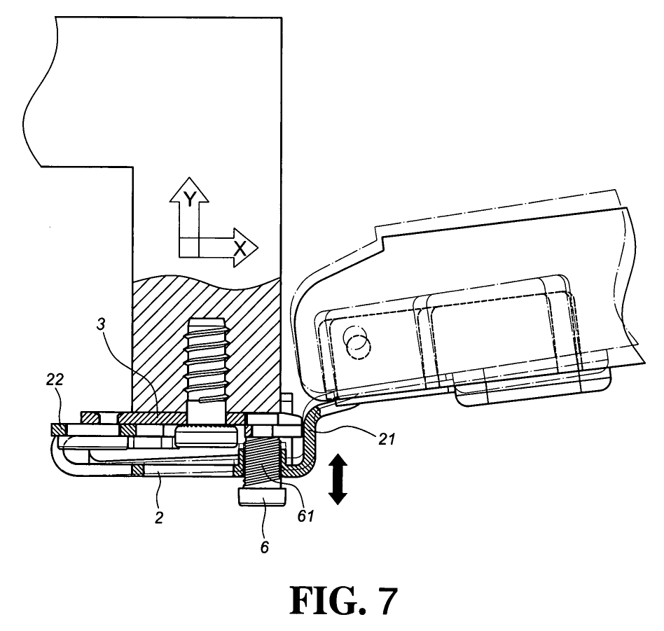

Similarly, with the locating plate (3) serving as a reference point without moving as illustrated in FIG. 7, the adjustment screw (6) is turned for the threaded portion (61) to drive the extension plate (2) moving toward the side closer to the arm (21) thus to execute displacement in a direction of axis Y according to the coordinates illustrated in FIG. 7. Meanwhile, a curved section from the joint (22) of the extension plate (2) provides adjustment flexibility.

What is claimed is:

1. A multi-directional adjustment hinge comprising:
a head plate containing a chamber;
an extension plate having two opposite ends and a through hole at a central portion between the two ends, two sidewalls being provided at two sides of the extension plate, an arm extending from one end of the extension plate to be inserted into the chamber of the head plate, a joint extending from the other end of the extension plate and being bent inwardly, side edges of the joint and the sidewalls being separated from each other for a given space;
a locating plate having two lips at two sides of the locating plate, each of the lips being provided with a protruding tab, the lips being inserted between the sidewalls of the extension plate and the side edges of the joint with the protruding tabs holding against the joint;
a pivot pin penetrating through the arm of the extension plate and the head plate to pivot the arm to the head plate;
a spring tongue having a locating portion and a force-applying portion with the locating portion secured in the chamber of the head plate and the force-applying portion penetrating through and holding the arm of the extension plate;
an adjustment screw being engaged to the locating plate at where closer to the arm; and
an adjustment cam penetrating through and holding against the joint to be secured to the locating plate.

2. The multi-directional adjustment hinge as claimed in claim 1, wherein locating pieces and retainers are disposed in the chamber of the head plate to hold against the locating portion of the spring tongue and compressing the locating portion to be secured in position.

3. The multi-directional adjustment hinge as claimed in claim 2, wherein the retainers correspond in position to an edge of the locating portion of the spring tongue.

4. The multi-directional adjustment hinge as claimed in claim 1, wherein a cam portion is formed on an end of the arm of the extension plate and is inserted through by the pivot pin; the arm is formed with a slot adjacent to the cam portion; and the force-applying portion of the spring tongue penetrates through the slot to hold the cam portion.

5. The multi-directional adjustment hinge as claimed in claim 1, wherein the joint of the extension plate is provided with a slit;
the locating plate is provided with a through hole; the adjustment cam has a riveting end and a cam base; the riveting end connects the adjustment cam to the through hole of the locating plate; and the cam base is received in the slit of the joint of the extension plate.

6. The multi-directional adjustment hinge as claimed in claim 1, wherein the extension plate is formed with a threaded hole at the end near the arm; the locating plate is formed with an insertion recess; the adjustment screw has a threaded portion and a ring groove; the threaded portion of the adjustment screw penetrates through the threaded hole; and the ring groove of the adjustment screw engages with the insertion recess.

7. The multi-directional adjustment hinge as claimed in claim 1, wherein two retaining tabs and a strip hole are disposed on one end of the locating plate.
